(19) United States
(12) Patent Application Publication
(10) Pub. No.: US 2024/0288329 A1
(43) Pub. Date: Aug. 29, 2024

(54) AUTOMATED LEAK DETECTION METHOD USING A ROBOTIC SNIFFER LEAK DETECTOR

(71) Applicant: INFICON GmbH, Köln (DE)

(72) Inventors: Daniel Wetzig, Köln (DE); Silvio Decker, Köln (DE); Jochen Puchalla-König, Köln (DE); Erik Rolff, Köln (DE); Volker Trieb, Köln (DE)

(21) Appl. No.: 18/693,121

(22) PCT Filed: Jul. 25, 2022
(86) PCT No.: PCT/EP2022/070813

§ 371 Date: Mar. 18, 2024

(30) Foreign Application Priority Data
Oct. 7, 2021 (DE) 10 2021 126 030.2

(51) Int. Cl. G01M 3/04

(52) U.S. Cl. CPC G01M 3/04

(57) ABSTRACT

The invention relates to an automated leak detection method using a robotic gas leak detector (56), characterized by the steps of:
a) moving the probe tip (25) of a probe (22) guided by a robot (32) to a test site (20) to be examined, using a robot (32);
b) recording a measurement signal from gas recorded by the probe tip (25) by means of a gas detector (24);
c) detecting at least one first measurement value of the measurement signal at at least one first measurement time;
d) detecting the first measurement time and assigning the first measurement time to the first measurement value;
e) detecting and assigning a first measurement position of the probe (22) corresponding to the first measurement time;
f) repeating steps a)-e) for at least one subsequent second measurement time;
g) correlating the measurement values with each of the measurement positions of the probe (22) in order to be able to use the measurement values to assess at which measurement position an extreme value of the measurement signal, which could indicate a possible leak in the test object, was detected.

The invention relates to a leak detector for the detection of leaks in a test object.

A leak detector is described in DE 10 2005 022 156 A1 (Inficon), for example. This leak detector comprises a probe, the sniffer tip of which is placed at predetermined test regions of a test object. The test object is filled with a test gas, e.g. helium. Escaping test gas is drawn in by a base unit via the sniffer tip and is supplied to a test gas detector which may, for example, be configured as a mass spectrometer.

When leak detectors are used, the test object, e.g. an air conditioning system or the refrigeration unit of a refrigerator, is filled with a test gas, and a sniffer probe can be used to detect whether test gas escapes from the test object. When testing the quality of products in the industry, the sniffer tip is placed on specific test regions of the test object, in which a leak may possibly be present. Here, the probe is manually moved to the test regions. In this process, it is difficult to check whether the sniffer tip has been moved to all relevant test regions of the test objects. An operator may inadvertently omit certain test regions or skip other test regions which he may consider to be non-critical according to his subjective assessment.

U.S. Pat. No. 4,945,305 (Ascension) describes a positioning system comprising a transmitter for generating a pulsed DC magnetic field and a receiver which is arranged on the object. This method is particularly useful for determining a current position, comparing the same with a desired position, and for a feedback. No interference is caused by non-magnetic objects in the line of sight between the transmitter and the receiver. Residual interference by large masses of magnetizable material, such as a compressor block and a refrigeration machine, can be eliminated by calibration, since the arrangement to be tested is static. This method has proven to be particularly useful for the implementation of the disclosure.

WO 2009/016160 A1 describes a leak detector comprising a base unit which is connected to a probe via a pipe. The sniffer tip is positioned on test zones or test regions of the test object. In a case in which test gas escapes from the test object, the same is detected by a test gas detector in the base unit. A positioning system is provided which comprises a transmitter, a receiver arranged in the probe, and a supply and evaluation unit. Thereby, the presence of the sniffer probe in the individual test regions is monitored and confirmed.

In the field of automation, it is known to acquire digital data of physical objects by using a 3D sensor to thereby obtain a point cloud in a 3-dimensional virtual space, the points each representing one surface point on the outer surface of the physical object. Robots used in automation industry, e.g. in the automated manufacture of products such as cars, are controlled by software algorithms in which the acquired digital data are used. This is generally done to sense the outer circumference or surfaces of the entire physical object in order to localize, grip, move or relocate the object or to paint the outer surface of the object by means of a paint spraying robot arm, for example in the vehicle manufacturing industry.

Sniffer leak detection on heat exchange devices, such as refrigerators, air conditioning systems, heat pumps, etc., is part of the quality test of heat exchange devices. A human operator has to visually identify the relevant test regions on the heat exchanger, such as liquid-carrying pipes, and manually move the probe to the test regions one after the other. This type of sniffer leak detection on heat exchange devices is time consuming and prone to human factor errors such as skipping test regions or not bringing the sniffer probe close enough to a test region.

The invention is based on the object of providing a more reliable and faster detection of a leak in a fluid-carrying element of a heat exchange device.

The method according to the invention is defined by the features of independent claim 1.

Accordingly, the probe tip of a probe guided by a robot is moved to a test location to be examined using a robot (step a) and, after reaching the test location, gas or air is drawn through the probe tip and supplied to a gas detector, with which a measurement signal of the drawn-in gas is recorded (step b). At least one first measured value of the measurement signal is acquired at at least one first point in time (step c). The probe tip typically draws in the gas or ambient air as it approaches the test location and is not only activated once the test location has been reached. In addition, the first measurement time is acquired and assigned to the first measured value (step d). Finally, a first measurement position of the probe corresponding to the first measurement time is also acquired (step e). Thus, position data are obtained which indicate the position of a component of the probe, for example the probe tip, which the component has assumed at the first measurement time. Each signal value I of the gas measurement is therefore assigned a time t of the measurement and a location or position in space (x,y,z) as I(t,x,y,z). If required, spatial angle coordinates in the form of two spatial angles Φ, Θ and a distance r (r, Φ, Θ) of the axis can be acquired along the probe in addition or as an alternative to the spatial coordinates of a Cartesian coordinate system. These steps are repeated for at least one subsequent second measurement time (step f), wherein, according to the invention, the measurement values are correlated with each of the measurement positions in order to be able to use the measurement values to assess at which measurement position an extreme value of the measurement signal, which could indicate a possible leak in the test object, was detected (step g). In this way, fully automated leak detection using a robot is to be performed without a human user carrying out the evaluation, operation and/or leak detection or individual steps thereof.

After performing step e) and before performing step f), the probe tip can be moved by the robot to another test location in order to repeat the measurement for another test location. As an alternative or in addition, steps b)-g) can be repeated after the probe tip has been moved from the robot to another test location. The measurement position of the probe tip, for example, is preferably detected by means of a 3D sensor, which may be an imaging system with at least one optical camera and preferably at least one illumination device.

During the recording of the measurement signal, the probe can be moved by the robot to continuously take different measurement positions during the measurement. The measured values can be acquired as a function of the measuring position of the probe and/or the movement speed of the probe. Preferably, the measurement signal is evaluated depending on the measurement position of the probe tip.

Advantageously, at least two measurements are performed at the same measuring position and the measured values acquired are compared with each other.

The measurement signal can be evaluated considering the speed at which the probe is moved during the measurement.

While the probe is being moved to the test location and before the measurement is made, the probe signal can be zeroed by using the gas detector to acquire a measurement signal at a location where no tracer gas is known to be present and/or where there is a constant background concentration.

Or the signal zero adjustment is performed on the path of the probe tip to the test location, at a sufficiently large distance from the test location, so that the background signal (zero adjustment) can be determined.

The leak detection system can be calibrated by moving the probe to a point (e.g. test leak) where a known defined leak rate is emitted.

The probe can be moved to a measuring position for which a leak was detected or suspected during a previous measurement in order to perform a control measurement at the measuring position.

Those measuring positions, for which leaks are assumed from the previous measurements, are preferably marked.

The feed rate of the gas flow taken in by the probe can be adjusted as a function of the movement speed of the probe.

The gas leak detector may, for example, be a sniffer leak detector with a sniffer probe having a sniffer tip through which the gas is drawn in. As an alternative, the gas leak detector can comprise a test gas probe, the detector tip including the gas detector for the test gas.

In the following, an exemplary embodiment of the invention is explained in detail with reference to the FIGURE. The FIGURE shows a schematic illustration of a leak detection system and a test object in the form of a heat exchanger device. The embodiment illustrated shows a gas leak detector in the form of a sniffer leak detector, the probe of which is a sniffer probe through the sniffer tip of which the gas to be analyzed is drawn in.

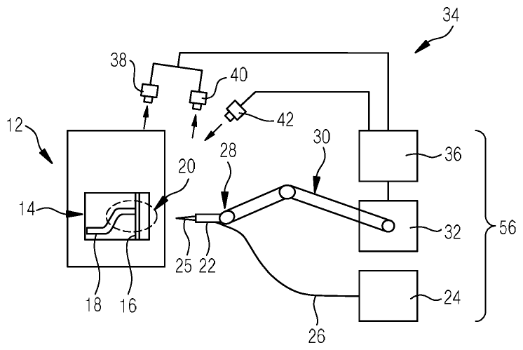

FIG. 1 shows a heat exchanger device 12 in the form of a refrigerator. The term “heat exchanger device” as used in the present disclosure refers to systems or devices which comprise a heat exchanger, such as refrigerators, air conditioners, heat pumps, etc. On its lower rear side 14, the heat exchanger device has a plurality of fluid-carrying elements 16, 18 in the form of pipes which are welded or soldered to the rear side of the refrigerator in the manufacturing process. As a part of a fully automated quality control, specific test regions 20 have to be identified for performing a leak detection in the test regions 20. A test region 20 is considered a region of the heat exchanger device in which pipes are mounted, welded or soldered to each other, in which a pipe ends, in which a pipe is connected to another pipe or in which pipes are joined or cross each other. In the embodiment shown in FIG. 1, a first fluid-carrying element 16 is vertically arranged and a second fluid-carrying element 18 has one of its ends connected to the first fluid-carrying element 16. The region in which the pipes 16, 18 are connected, is considered to be the test region 20 and is illustrated as a dashed circle in FIG. 1.

The background of the invention is automatic movement of a sniffer probe 22 of a sniffer leak detector 24 to the test region 20, so that the sniffer probe 25 of the sniffer probe 22 is positioned close enough to draw in gas escaping from a possible leak in one of the pipes 16, 18 in the test region 20. The sniffer probe 22 is connected to the gas leak detector 24 in a conventional manner via a connecting pipe or connecting capillaries 26. The objective is to correlate the movement of the sniffer probe and the associated signal reaction of the measured signal.

The sniffer probe 22 is mounted on the distal end 28 of a robot arm 30 of a robot 32.

A 3D sensor 34 in the form of an imaging system 36, which comprises two optical cameras 38, 40 and an illumination device 42 in the form of a LED light, acquires digital image data from the lower rear side 14 of the heat exchanger device 12. In a manner known per se, the illumination device 42 illuminates the heat exchanger device 12 and in particular the lower rear side 14 of the heat exchanger device 12. The cameras 38, 40 capture the reflected light, and the imaging system 36 generates digital image data from which a point cloud 44 in a 3-dimensional virtual space 48 is acquired. As an alternative, it is possible to infer the position of the measuring probe from the known position of the robot arm. The robot arm is guided to known measurement positions. Knowing the size and the orientation of the measuring probe relative to the robot arm, it is possible to determine the position of the measuring probe.

According to the invention, the gas detector 24 is used to acquire measurement values of the measurement signal of a gas flow drawn in through the sniffer tip 25 and to detect the measurement times related to each measurement value and to assign them to the measurement values. Moreover, the respective measurement positions of the sniffer tip 25 are detected at each measurement time by capturing the position of the sniffer tip, i.e. the relative position of the sniffer tip 25 relative to the test object 12 or the measurement location 20 by means of the cameras 38, 40 of the 3D sensor 34.

During the evaluation of the measurement values, the same are compared with the respective measurement positions so as to be able to conclude on the location of a possible leak from the measurement positions of the respective measurement values and from the amplitudes of the measurement values.

A typical case of a necessary signal correlation is caused by the delay of the signal response due to the travel time of the gas through the sniffer line 26. After a test gas cloud has been drawn into the sniffer tip 25, the gas travels through the line 26 to the main device of the gas detector 24. This travel time, also referred to as dead time, can be up to several seconds. This means that the sniffer probe 22 may already have been moved by the robot arm 30 to the next measuring location at the time of a signal response at the gas detector 24 caused by an aspirated leakage gas cloud at a measuring location. This time delay must be taken into account when correctly assigning the measurement signal to the measurement location.

The gas flow time must be measured beforehand. This can be done, for example, during calibration of the system. For this purpose, the robot arm 30 positions the tip 25 of the sniffer probe 22 in front of a test leak. Here, the delay time between approaching the test leak and the signal response is measured. This delay time is then taken into account when interpreting the signal responses at the gas detector 24 and assigning the leakage points on the test object.

1-15. (canceled)

16. An automated leak detection method using a robotic gas leak detector, characterized by the steps of:
a) moving the probe tip of a probe guided by a robot to a test site to be examined, using a robot;
b) recording a measurement signal from gas recorded by the probe tip by means of a gas detector;
c) detecting at least one first measurement value of the measurement signal at at least one first measurement time;
d) detecting the first measurement time and assigning the first measurement time to the first measurement value;
e) detecting and assigning a first measurement position of the probe corresponding to the first measurement time;
f) repeating steps a)-e) for at least one subsequent second measurement time;
g) correlating the measurement values with each of the measurement positions of the probe in order to be able to use the measurement values to assess at which measurement position an extreme value of the measurement signal, which could indicate a possible leak in the test object, was detected.

17. The leak detection method according to claim 16, wherein the robot moves the probe tip to another test location after the execution of step e) and before the execution of step f).

18. The leak detection method according to claim 16, wherein steps b)-g) are repeated after the robot has moved the probe tip to another test location.

19. The leak detection method according to claim 16, wherein according to step e), the measurement position of the probe is detected using a 3D sensor.

20. The leak detection method according to claim 16, wherein according to step e), the measurement position of the probe is inferred from the known position of the arm of the robot carrying the probe.

21. The leak detection method according to claim 16, wherein the probe is moved by the robot during the acquisition of the measurement signal and thereby continuously assumes different measurement positions.

22. The leak detection method according to claim 16, wherein the measurement values are acquired as a function of the measurement position of the probe and/or the movement speed of the probe.

23. The leak detection method according to claim 16, wherein the evaluation of the measurement signal is performed in dependence on the measurement position of the probe tip.

24. The leak detection method according to claim 16, wherein at least two measurements are performed at the same measurement position and the acquired measurement values are compared with each other.

25. The leak detection method according to claim 16, wherein the evaluation of the measurement signal is performed with consideration to the speed at which the probe is moved during the measurement.

26. The leak detection method according to claim 16, wherein during step a) and before step b), a calibration of the probe by a zero adjustment is performed by acquiring a measurement signal by means of the gas detector and storing the same as a background signal.

27. The leak detection method according to claim 16, wherein the probe is moved to a measurement position for which a leak was determined before, so as to perform a control measurement at the measurement position.

28. The leak detection method according to claim 16, wherein those measurement positions are marked for which leaks are assumed from previous measurements.

29. The leak detection method according to claim 16, wherein the feed rate of the gas flow drawn in by the probe is adjusted in dependence on the movement speed of the probe.

30. The leak detection method according to claim 16, wherein the gas leak detector is a sniffer leak detector, the probe is a sniffer probe and the probe tip is a sniffer tip.
